(19) United States
(12) Patent Application Publication
(10) Pub. No.: US 2012/0182619 A1
(43) Pub. Date: Jul. 19, 2012

(54) TUNABLE FREQUENCY SELECTOR

(75) Inventors: Grigory Valentinovich Gelikonov, Nizhny Novgorod (RU); Valentin Mikhailovich Gelikonov, Nizhny Novgorod (RU); Alexandr Alexandrovich Moiseev, Nizhny Novgorod (RU); Evgeny Alexandrovich Mashkovich, Nizhny Novgorod (RU)

(73) Assignee: Limited Liability Company "Biomedical technologies", Nizhny Novgorod (RU)

(21) Appl. No.: 13/351,407

(22) Filed: Jan. 17, 2012

Related U.S. Application Data
(63) Continuation of application No. PCT/RU2010/000388, filed on Jul. 15, 2010.

(30) Foreign Application Priority Data
Jul. 17, 2009 (RU) 2009127671

(51) Int. Cl. G02B 26/00

(52) U.S. Cl. 359/578

(57) ABSTRACT

The invention relates to laser technology and can be used for creating tunable lasers in the near IR region for swept source optical coherence tomography.

The developed tunable frequency selector is used for a tunable laser with a shortest possible optical length of the active cavity comprising a frequency selector for operation in the regime of single longitudinal mode generation. The use of the frequency selector as one of the laser mirrors reduces the number of adjustments of laser optical elements and laser costs. To achieve this goal, a waveguide with a mode size of several wavelengths is positioned in front of the Fabry-Perot cavity. The modes of the waveguide and the Fabry-Perot cavity are partially matched. The Fabry-Perot cavity may be tilted relative to the optical axis of the waveguide. The Fabry-Perot cavity may comprise two minors, at least one of which is convex, or two minors, at least one of which has no radial symmetry. A lens system comprising at least one lens may be positioned between the waveguide and the Fabry-Perot cavity. The tunable frequency selector may be used as an output mirror of a tunable laser. A lens system comprising at least one lens may be used after the Fabry-Perot cavity. To change the optical distance between the mirrors of the Fabry-Perot cavity, an actuator may be used in the tunable frequency selector.

### RELATED APPLICATIONS

This application is a continuation of International Application PCT/RU2010/000388 filed on Jul. 15, 2010, which is turn claims priority to Russian Patent Application RU 2009127671 filed on Jul. 17, 2009, both of which are incorporated hereby in their entirety.

### FIELD OF THE INVENTION

The invention relates to laser technology and can be used for creating tunable lasers in the near IR region for swept source optical coherence tomography.

Tunable laser applications encompass diverse fields of science and technology. Depending on application, different requirements are specified to laser tuning range, central wavelength, output power, and spectral bandwidth. These characteristics are related directly to the type of tunable frequency selector utilized for developing a tunable laser. Another important characteristic for quite a number of applications is the generation regime (single or multimode generation) of a tunable source. Generation at a single longitudinal mode is attained when only one longitudinal mode of the active cavity gets to a narrow spectral band of the tunable frequency selector. The distance between the longitudinal modes is determined by the optical length of the active cavity.

### BACKGROUND OF THE INVENTION

U.S. Pat. No. 7,242,697 (publ. Oct. 7, 2007) describes a tunable frequency selector comprising a polarizer, two reflective plates with a variable refractive index medium in between (Fabry-Perot cavity) placed between two Faraday rotators, and a reflective mirror. Broadband radiation reaches the polarizer, passes through it acquiring linear polarization, passes the Faraday rotators and the Fabry-Perot cavity, reflects from the reflective mirror, passes the Faraday rotators and the Fabry-Perot cavity again, passes the polarizer once more, and returns to the system. The radiation reflected by the front reflective plate of the Fabry-Perot cavity is blocked by the polarizer. The radiation spectrum at the output of the tunable frequency selector is a narrow spectral band. Frequency tuning is performed by changing the refractive index of the medium filling the space between the two reflective plates.

The drawback of this tunable frequency selector is a large number of optical elements inside the active cavity, which increases its optical length and impedes construction of a tunable laser generating at one longitudinal mode.

The closest analog of the proposed tunable frequency selector is a frequency selector described in U.S. Pat. No. 6,301,274 (publ. Sep. 10, 2001). This tunable frequency selector consists of a lens, a Fabry-Perot cavity tilted relative to the optical axis of the system at a rather large angle to prevent backreflection from the front mirror, and a reflective mirror. Broadband radiation passes through the lens that matches the mode of the active medium used for creation of a tunable laser and the Fabry-Perot cavity mode, then passes through the Fabry-Perot cavity, reflects from the reflective mirror, passes the Fabry-Perot cavity and the lens once again, and comes back to the system. The resulting radiation spectrum represents a narrow spectral band. The frequency is tuned by changing the length of the Fabry-Perot cavity.

As compared to the device described above (U.S. Pat. No. 7,242,697), the tunable laser utilizing this tunable frequency selector will have fewer optical elements inside active cavity, but the optical length of such a laser may be further decreased if the tunable frequency selector is used as one of the laser mirrors.

### SUMMARY OF THE INVENTION

The object of the present invention is development of a tunable frequency selector for a tunable laser with the shortest possible optical length of the active cavity comprising a frequency selector that would operate in the regime of single longitudinal mode generation. Using the frequency selector as one of the laser mirrors reduces the number of adjustments of the laser optical elements and laser costs.

This technical result is achieved by the developed tunable frequency selector having a Fabry-Perot cavity with variable optical length between the mirrors. In the developed tunable frequency selector a waveguide with mode size equal to several wavelengths is positioned in front of the Fabry-Perot cavity, wherein the modes of the waveguide and Fabry-Perot cavity are partially matched.

In one embodiment of the tunable frequency selector, the Fabry-Perot cavity is tilted relative to an optical axis of the waveguide.

In a second embodiment, the Fabry-Perot cavity comprises two mirrors, at least one of which is convex.

In a third embodiment of the tunable frequency selector, the Fabry-Perot cavity comprises two mirrors, at least one of which has no radial symmetry.

In a fourth embodiment of the tunable frequency selector, a lens system comprising at least one lens is placed between the waveguide and the Fabry-Perot cavity.

In a fifth embodiment of the tunable frequency selector, it is arranged as an output mirror of a tunable laser.

In a sixth embodiment of the tunable frequency selector, a lens system comprising at least one lens is placed after the Fabry-Perot cavity.

In a seventh embodiment the tunable frequency selector further comprises a piezoceramic actuator for changing an optical distance between the mirrors of the Fabry-Perot cavity.

### BRIEF DESCRIPTION OF DRAWINGS

FIG. 1 illustrates an embodiment of a tunable frequency selector with a waveguide and a Fabry-Perot cavity with partially matched modes;

FIG. 2 illustrates an embodiment of the tunable frequency selector with the waveguide and the Fabry-Perot cavity tilted relative to the waveguide optical axis;

FIG. 3 represents reciprocal geometry of the incident Gaussian beam and of the open optical cavity mode for the case of mismatched waist size and position;

FIG. 4 represents reciprocal geometry of the incident Gaussian beam and of the open optical cavity mode for the case of their angular and axial displacement mismatch;

FIG. 5 represents fractions of power (relative to the power of incident radiation) of the broadband radiation of the incident Gaussian beam reflected from the front concave mirror and of the mode of the open optical cavity with narrow band spectrum backreflected to the waveguide versus the angle between the waveguide axis and the open optical cavity;

FIG. 6 represents spectra of the radiation backreflected to the waveguide from the open optical cavity versus the angle between the waveguide axis and the axis of open optical cavity;

FIG. 7 illustrates an embodiment of the tunable frequency selector using a waveguide and a Fabry-Perot cavity with one convex mirror;

FIG. 8 illustrates an embodiment of the tunable frequency selector with a waveguide, a lens, and a Fabry-Perot cavity;

FIG. 9 illustrates an embodiment of the tunable frequency selector with a lens after the Fabry-Perot cavity for outputting of selected radiation.

### DETAILED DESCRIPTION OF THE INVENTION

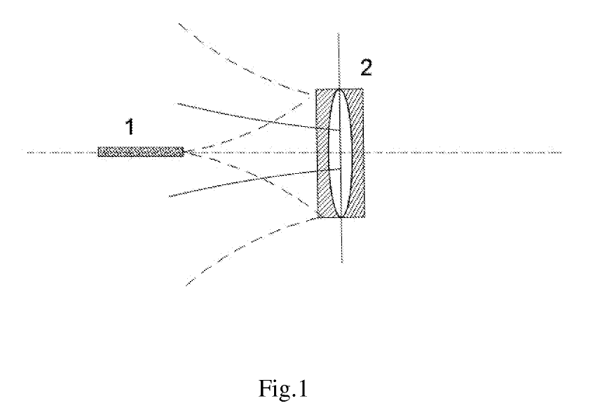

The tunable frequency selector as shown in FIG. 1 in a general embodiment comprises waveguide 1 and Fabry-Perot cavity 2, with mode waist size of several wavelengths and partially matched modes of the open optical Fabry-Perot cavity and the waveguide.

The character of the radiation backreflected to the waveguide is determined by the coupling coefficients

$${C}_{\overline{p} \overline{l}}^{pl}$$

of the waveguide mode and the open optical cavity mode, where p, l, p̅, l̅ are the indices of the cavity and waveguide mode, respectively. The fraction of the power transferred from the waveguide mode with indices p̅, l̅ to the excited mode of the Fabry-Perot cavity with indices p, l is defined by

$${\vert {C}_{\overline{p} \overline{l}}^{pl} \vert}^{2} .$$

For the interaction of the waveguide mode that is a Gaussian beam having indices 0,0 with the mode having the same indices 0,0 of the Fabry-Perot cavity these coefficients are defined by

$$χ = {\vert {C}_{00}^{00} \vert}^{2} = {[ \frac{1}{4} {( \sqrt{\frac{\overline{{R}_{0}}}{{R}_{0}}} + \sqrt{\frac{{R}_{0}}{\overline{{R}_{0}}}} )}^{2} + \frac{{Λ}^{2}}{\overline{{R}_{0}} \cdot {R}_{0}} ]}^{- 1} \cdot exp ( \frac{{Δ}^{2}}{{ω}_{0}^{2}} \frac{{δ}^{2}}{{Ψ}_{0}^{2}} ) ,$$

where R₀, R̅₀̅ are the confocal parameters of the cavity and of the waveguide mode, respectively, ω=\sqrt{R₀/k} is the waist size of the fundamental mode of the Fabry-Perot cavity,

$${Ψ}_{0} = \frac{2}{\sqrt{{kR}_{0}}}$$

is the angle of divergence of the Fabry-Perot cavity mode, Λ is the distance between the waists of the waveguide mode and of the Fabry-Perot cavity mode, Δ is the distance between the axes of the waveguide mode and of the Fabry-Perot cavity mode, δ is the angle between the axes of the waveguide mode and of the Fabry-Perot cavity mode. The coefficient χ² indicates the fraction of radiated power with the spectrum of the Fabry-Perot cavity modes backreflected to the waveguide.

An analogous formula may be written for the fraction of power of the waveguide mode reflected from the front mirror and the Fabry-Perot cavity mirror and backreflected to the waveguide.

In the case of partial matching, it is possible to achieve a condition when the fraction of power backreflected to the waveguide will be much smaller for the waveguide mode reflected from the front minor than for the mode of the Fabry-Perot cavity. Then, the spectrum of the radiation backreflected to the waveguide will coincide with the spectrum of the Fabry-Perot cavity modes that represents narrow spectral bands. In this way it is possible to provide feedback in the laser exclusively for the resonance frequencies of the Fabry-Perot cavities. Specifically, using a semiconductor optical amplifier as a waveguide one can attain generation of a single longitudinal mode of active cavity.

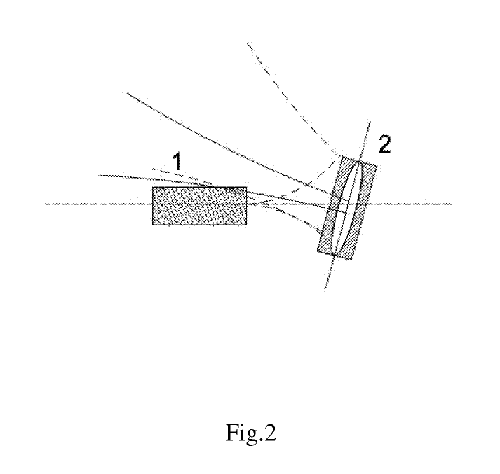

In the embodiment presented in FIG. 2, the tunable frequency selector comprises waiveguide 1 and Fabry-Perot cavity 2 having an angle with an optical axis of the system. A mismatch factor in this case is an angular mismatch g between axes of the waveguide mode and of the Fabry-Perot cavity mode.

Fractions of power of the waveguide mode reflected from the front mirror and of the Fabry-Perot cavity mode backreflected to the waveguide are now considered. The angular dependence of the fraction of power (relative to the radiation power incident on the Fabry-Perot cavity) of the Fabry-Perot cavity mode backreflected to the waveguide is proportional to 2 exp(−2δ²/Ψ₀²). The angular dependence of the fraction of power (relative to the radiation power incident on the Fabry-Perot cavity) of the radiation reflected from the front mirror and then backreflected to the waveguide is proportional to exp (−(2δ)²/Ψ₀² ), as the angle of reflection is equal to the angle of incidence. In a definite angular interval, less than 0.01 percent of the power of incident radiation reflected from the front mirror is backreflected to the waveguide, whereas the power of the Fabry-Perot cavity mode backreflected to the waveguide amounts to about 5% of the power of incident radiation, which is optimal for providing feedback in lasers based on semiconductor optical amplifiers with gain of order 10³. Frequency tuning is performed by changing the optical distance between the minors forming the Fabry-Perot cavity.

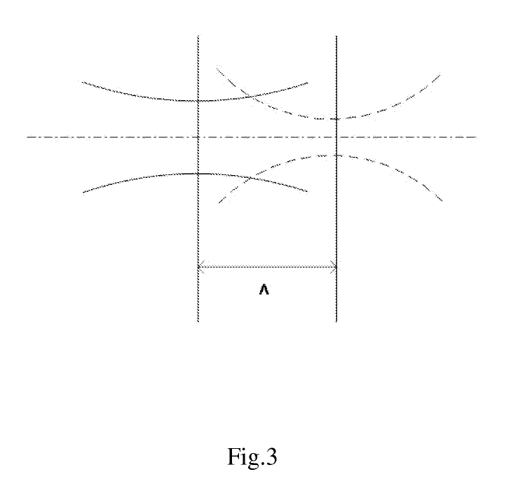

FIG. 3 explains the meaning of Λ—the distance between the waists of the incident Gaussian beam and of the Fabry-Perot cavity mode.

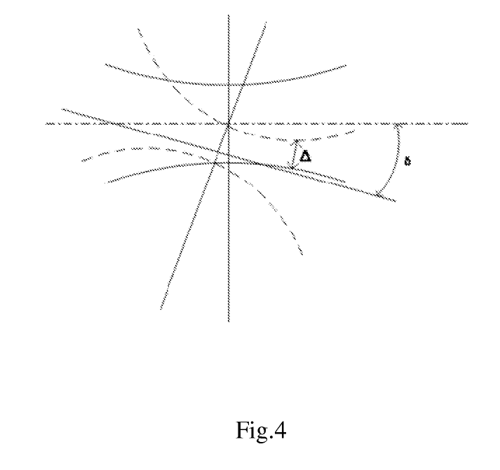

FIG. 4 explains the meaning of Δ—the distance between the axes of the incident Gaussian beam and the mode of the open optical cavity, and the value of δ that is the angle between the axes of the incident Gaussian beam and of the Fabry-Perot cavity mode.

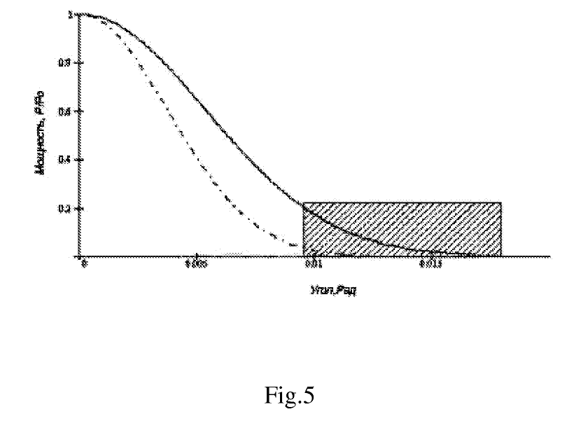

FIG. 5 shows the dependence of the fractions of power (relative to the power of incident radiation) of the waveguide mode radiation with a broad spectrum, reflected from the front convex mirror, and of the Fabry-Perot cavity mode radiation with a narrow band spectrum, backreflected to the waveguide, on the angle between the axes of the waveguide and of the Fabry-Perot cavity.

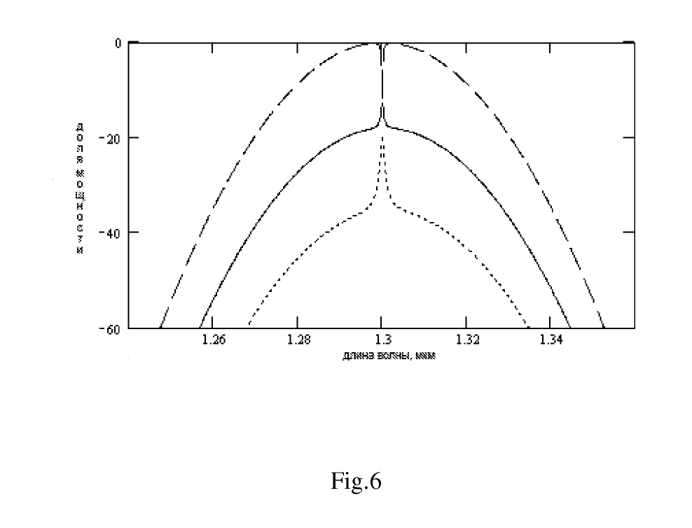

The spectra of the radiation backreflected to the waveguide from the Fabry-Perot cavity versus the angle between the axis of the open optical cavity and the waveguide axis are given in FIG. 6.

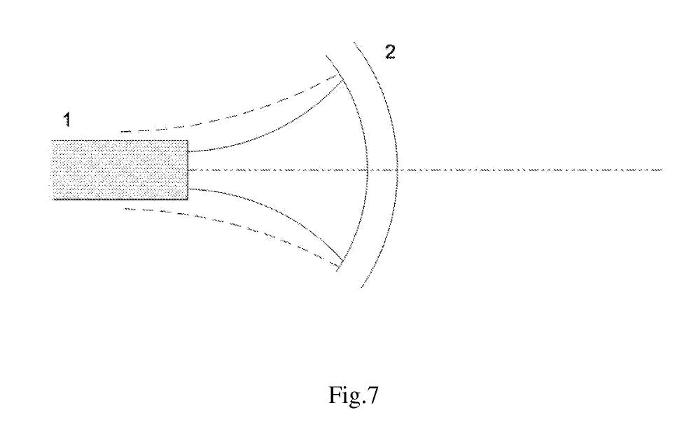

The tunable frequency selector shown in FIG. 7 comprises a waveguide 1 and an open optical cavity 2 with at least one convex mirror. The mode waist of this open optical cavity is outside the cavity and the mode waist size is equal to several wavelengths. In this case, it is possible to reduce the fraction of the power backreflected to the waveguide for the waveguide mode reflected from the front minor due to mismatch between the size and waist of the reflected and waveguide modes. Then, the fraction of power backreflected to the waveguide for the Fabry-Perot cavity mode will be several orders of magnitude higher than the fraction of power of the waveguide mode reflected from the front mirror and backreflected to the waveguide.

The waveguide mode—a Gaussian beam with 0,0 indices—incident on the Fabry-Perot cavity may excite not only the Fabry-Perot cavity mode with indices 0,0, but higher order modes also. As they have a frequency shift relative to the Fabry-Perot cavity mode with indices 0,0, generation at one longitudinal mode of the active cavity may be disturbed. To avoid this effect, the Fabry-Perot cavity may be made of mirrors without radial symmetry, as in this case the cavity modes will have no radial symmetry either and coupling coefficients (hence, fractions of power as well) for the modes of such a Fabry-Perot cavity with indices different from 0,0 will be several orders of magnitude less than for the Fabry-Perot cavity with 0,0 indices.

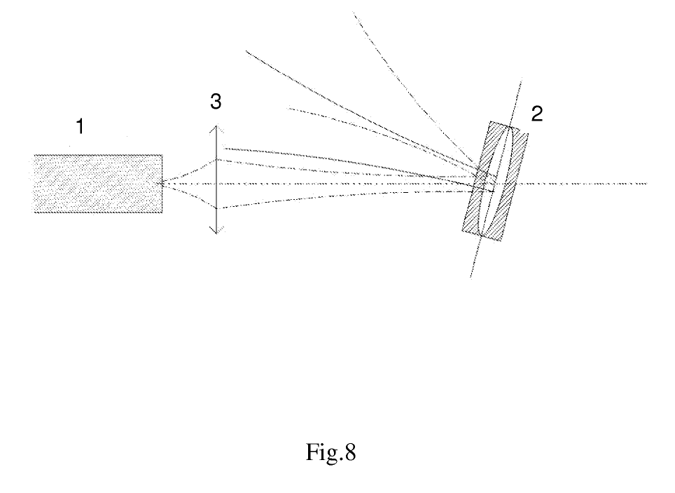

The tunable frequency selector illustrated in FIG. 8 comprises waveguide 1, Fabry-Perot cavity 2, and lens 3. With appropriate choice of spatial location and focal distance, the lens 3 placed behind the waveguide ensures additional matching of the Fabry-Perot cavity mode with the waveguide mode, better than for the waveguide mode reflected from the front minor of the Fabry-Perot cavity.

As the Fabry-Perot cavity mode is irradiated from the back side of the cavity, the proposed tunable frequency selector may be used as an output mirror of a tunable laser.

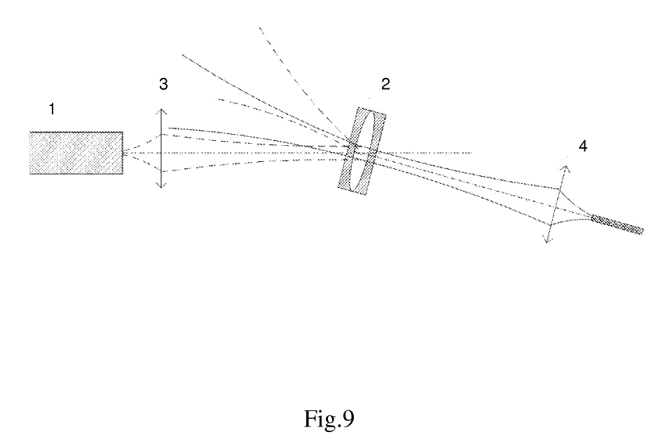

The tunable frequency selector of FIG. 9 comprises waveguide 1, lens 3 placed after the waveguide 1, Fabry-Perot cavity 2, and lens 4 placed on the back side of the Fabry-Perot cavity.

Like in the case of the tunable frequency selector shown in FIG. 8, the lens 3 and the Fabry-Perot cavity 2 provide backreflection to the waveguide of about 5% of incident radiation power with the spectrum of the reflected radiation in the form of narrow spectral bands. The lens 4 located on the back side of the Fabry-Perot cavity ensures matching of the Fabry-Perot cavity mode with the output of a device based on the tunable frequency selector, hence, the tunable frequency selector may be used as an output minor of a tunable laser.

### INDUSTRIAL APPLICABILITY

The developed tunable frequency selector was fabricated using up-to-date component parts. In a specific embodiment of the tunable frequency selector a Superlum semiconductor optical amplifier was used as the waveguide 1, and Grintech GT-IFRL-060-005-50-NC lens as the lens 3 between the waveguide and the Fabry-Perot cavity. The Fabry-Perot cavity was made of two concave mirrors with a radius of 1 m fabricated in the Institute of Applied Physics Russian Academy of Sciences (IAP RAS) using piezoceramic actuators to change optical length between minors. Grintech GT-LFRL-100-025-50-NC lens was taken for lens 4 on the back side of the cavity. Thus, the developed tunable frequency selector is used in a tunable laser with shortest possible optical length of the active cavity comprising the frequency selector for operation in the regime of single longitudinal mode generation. The use of the frequency selector as one of the laser mirrors reduces the number of adjustments of laser optical elements and laser costs.

The developed tunable frequency selector is ready for full-scale production.

What is claimed is:

1. A tunable frequency selector comprising a Fabry-Perot cavity with a variable optical length between its minors and a waveguide comprising an optical axis, the Fabry-Perot cavity having a mode and the waveguide having a mode, wherein a waist size of the Fabry-Perot cavity mode is several wavelengths, wherein the modes of the Fabry-Perot cavity and the waveguide are partially matched.

2. The tunable frequency selector of claim 1, wherein the Fabry-Perot cavity is tilted relative to the optical axis of the waveguide.

3. The tunable frequency selector of claim 1, wherein the Fabry-Perot cavity comprises two mirrors, at least one of which is convex.

4. The tunable frequency selector of claim 1, wherein the Fabry-Perot cavity comprises two concave mirrors of double curvature.

5. The tunable frequency selector of claim 1, wherein the Fabry-Perot cavity comprises two mirrors that do not possess radial symmetry and at least one of which is convex.

6. The tunable frequency selector of claim 1, further comprising a lens, which is positioned axis after the waveguide.

7. The tunable frequency selector of claim 1, further comprising an additional lens, which is positioned after the Fabry-Perot cavity.
